(19) United States
(12) Patent Application Publication
(10) Pub. No.: US 2002/0026402 A1
(43) Pub. Date: Feb. 28, 2002

(54) Electronic commercial transaction system

(76) Inventor: Eiji Okamura, Tokyo (JP)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 09/801,945

(22) Filed: Mar. 7, 2001

(30) Foreign Application Priority Data
Mar. 8, 2000 (JP) 2000-062800

(51) Int. Cl. G06F 17/60

(52) U.S. Cl. 705/37

(57) ABSTRACT

An electronic commercial transaction system is provided that instead of processing just a single electronic commercial transaction, offers comprehensive new electronic commercial transaction services related to the payment processing, goods processing, distribution processing, etc. that accompany electronic commercial transactions, and provides cheaper and more convenient service. The system is equipped with first electronic commercial transaction system 11 that handles the placing and receiving of orders, and second electronic commercial transaction system 12 that provides transactions related to processing derived from the placement or reception of orders handled by first electronic commercial transaction system 11. Second electronic commercial transaction system 12 is activated upon receipt of order placement or reception information that is transmitted from first electronic commercial transaction system 11. At least either first electronic commercial transaction system 11 or second electronic commercial transaction system 12 is capable of providing transactions by a bidding process.

### TECHNICAL FIELD

With regard to an electronic commercial transaction system for fashion goods such as fabric, secondary materials of clothing items or accessories, clothing items, shoes, bags, wallets, accessories, etc., and especially for electronic commercial transactions between materials wholesalers, processors, manufacturing wholesalers, intermediary wholesalers, and retail stores, the present invention relates to an electronic commercial transaction system that provides electronic commercial transaction services relating to the payment of the fee that accompanies a single transaction, the processing of goods for which an order was placed or received, packaging of goods for which an order was placed or received, collection/delivery and shipping of goods for which an order was placed or received, processing of labels attached to goods for which an order was placed or received, processing of tags that identify the goods, processing of tags that identify the origin of manufacture, or processing of tags that identify the origin of sale, etc.

### PRIOR ART

In conventional electronic commercial transaction systems, the sale or purchase of goods and the method of processing order placement and reception are selected and set within the same system.

As shown in FIG. 5, conventional electronic commercial transaction systems possess a single electronic commercial transaction system 19 and a transaction terminal 25. Electronic commercial transaction system 19 provided product information related to the transaction along with information such as payment conditions, delivery conditions, etc.

Payment condition related information presents the usable payment methods such as cash payment, bank transfer, credit card account debit, etc. and prompts for a selection to be made. Delivery condition related information prompts for a selection of the delivery date and time, etc.

### BACKGROUND OF THE INVENTION

However, when used between materials wholesalers, manufacturing wholesalers, intermediary wholesalers and retail stores, this type of conventional electronic commercial transaction could not provide adequate service simply by allowing selection of the payment method and delivery date and time.

In the case where a manufacturing wholesaler has purchased some materials from a materials wholesaler, inevitably the materials must be processed according to the placed or received order. Moreover, in the case where the manufacturing wholesaler does not perform the manufacturing and processing in-house, the selection of a processor that places outside orders and issuance of orders to that processor will be continuously implemented.

Further, when orders for commission-based processing are placed with the processor, along with the placed order, the delivery destination of the purchased goods is determined. It is necessary to select a suitable shipping company in accordance with the delivery location, and the shape and weight of the goods to be shipped. New transactions will be generated with the shipping company.

Also, regarding payment methods, there are many types of payment services offered by financial organizations. Because each service differs with respect to the time, date, handling fees, etc. required for payment settlement, a service must be selected on a commission basis, and new transactions will be generated with the financial organization.

This state, in which new transactions are generated from a single original transaction, applies not only to the examples of transactions with materials wholesalers, manufacturing wholesalers, and manufacturers, but also to transactions with intermediary wholesalers, retail stores, etc.

The original goal of using an electronic commercial transaction system is to obtain less expensive goods and to initiate new transactions with parties for which there have been no transactions previously. This tendency is especially remarkable when there is a bidding process.

However, in conventional electronic commercial transaction systems, the payment conditions, delivery conditions, etc. are incorporated into the same system. It is difficult to select the processing of goods and the processing after establishment of transactions for delivery, payment, etc. from the limited selection of less expensive choices.

### SUMMARY OF THE INVENTION

The electronic commercial transaction system of the present invention is equipped with a first electronic commercial transaction system that handles the placing or receiving of orders, and a second electronic commercial transaction system that provides transactions related to the processing derived from the placed or received order handled by the first electronic commercial transaction system.

The second electronic commercial transaction system is activated upon receipt of order placing or receiving information transmitted from the first electronic commercial transaction system.

At least either the first electronic commercial transaction system or the second electronic commercial transaction system provides transactions by a bidding process.

### BRIEF DESCRIPTION OF THE DRAWINGS

FIG. 1 Block diagram showing the first preferred embodiment of the electronic commercial transaction system of the present invention.

FIG. 2 Block diagram showing the second preferred embodiment of the electronic commercial transaction system of the present invention.

FIG. 3 Block diagram showing the third preferred embodiment of the electronic commercial transaction system of the present invention.

FIG. 4 Block diagram showing the fourth preferred embodiment of the electronic commercial transaction system of the present invention.

FIG. 5 Block diagram showing an example of the conventional electronic commercial transaction system.

### EXPLANATION OF REFERENCE NUMERALS

11, 13, 15, 17 First electronic commercial transaction system

12, 14, 15, 18 Second electronic commercial transaction system

21 to 25 Transaction terminal

31 to 24 Information route

### DETAILED DESCRIPTIONS

(First Preferred Embodiment)

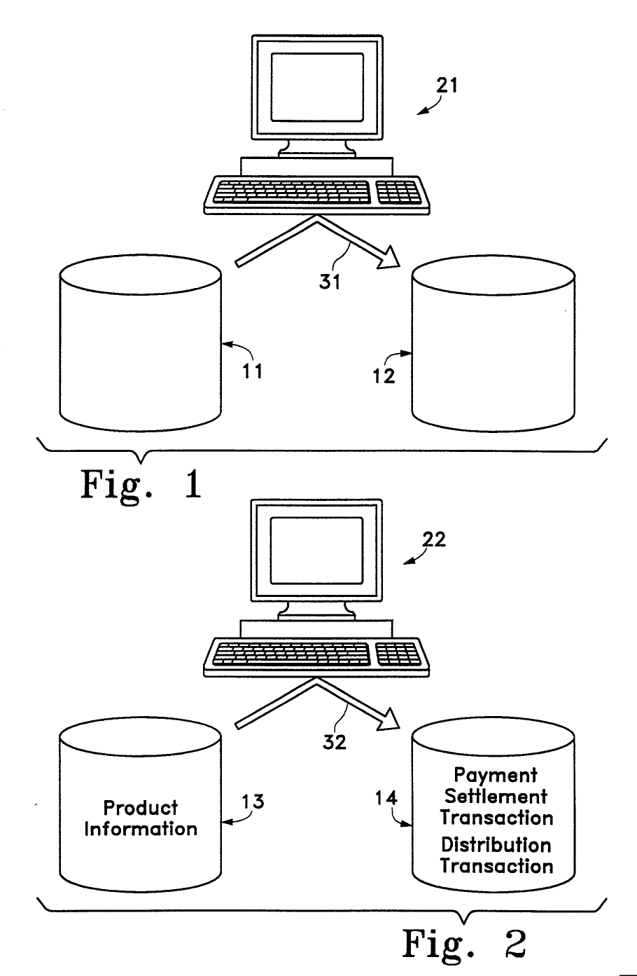

The basic configuration of the electronic commercial transaction system of the present invention is, as shown in FIG. 1, comprised of a first electronic commercial transaction system 11, a second electronic commercial transaction system 12, a transaction terminal 21 and information routes 31. First electronic commercial transaction system 11 and second electronic commercial transaction system 12 provide services and perform electronic transactions on transaction terminal 21.

First electronic commercial transaction system 11 and second electronic commercial transaction system 12 can provide transactions by a bidding process. Moreover, second electronic commercial transaction system 12 provides transactions related to the processing derived from the placed or received order handled by the first electronic commercial transaction system.

Next, the operation of the first preferred embodiment of the electronic commercial transaction system of the present invention will be described.

Service of first electronic commercial transaction system 11 progresses on transaction terminal 21, and when an order is placed or received or information relating to the placement or reception of an order is obtained, that information is transmit via information route 31 to second electronic commercial transaction system 12, and second electronic commercial transaction system 12 activates.

Second electronic commercial transaction system 12 provides new electronic commercial transaction services which are related to the processing derived from the order placement or reception that was generated with first electronic commercial transaction system 11.

Among electronic commercial transactions, bidding process transactions are a known means to purchase inexpensive goods. The electronic commercial transaction system of the present invention can implement these bidding process transactions.

Namely, in the case of using an electronic commercial transaction to obtain inexpensive goods, when placing an order for the desired goods on first electronic commercial transaction system 11, if first electronic commercial transaction system 11 provides bidding process transactions, then procurement of inexpensive goods can be expected.

When placement of an order with first electronic commercial transaction system 11 becomes decided, second electronic commercial transaction system 12 activates. At this time, because information related to the placed or received order from first electronic commercial transaction system 11 is transmitted to second electronic commercial transaction system 12, second electronic commercial transaction system 12 comprehends the processing derived from the order placed or received with first electronic commercial transaction system 11, and initiates electronic commercial transaction service related to that processing. The processing means for that item will be widely presented.

Inexpensive means are anticipated for services provided by second electronic commercial transaction system 12, and, if there are bidding process transactions, for the processing accompanying placed or received orders.

(Second Preferred Embodiment)

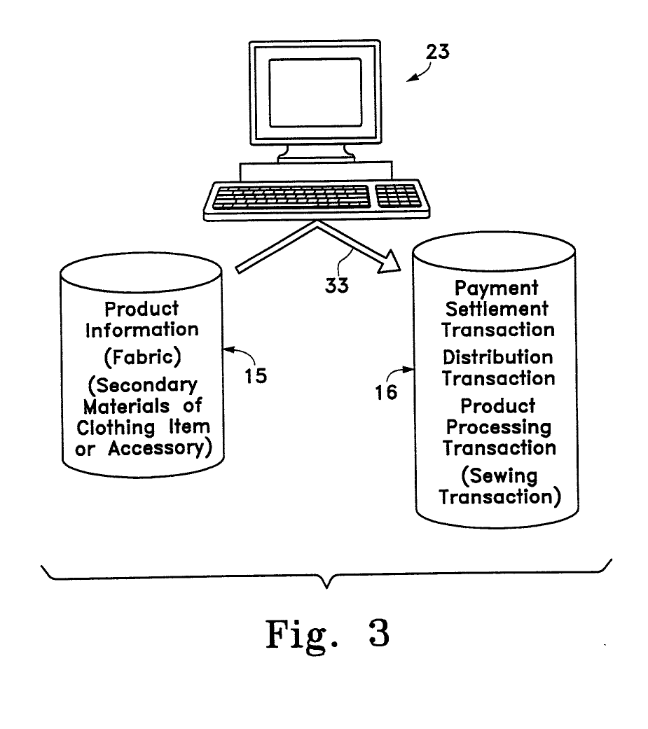

FIG. 2 shows the second preferred embodiment of the electronic commercial transaction system of the present invention. This electronic commercial transaction system provides transactions for payment settlement and distribution derived especially from the buying and selling of merchandise.

As shown in FIG. 2, [this embodiment] is comprised of first electronic commercial transaction system 13, second electronic commercial transaction system 14, transaction terminal 22, and information route 32. Similar to the first preferred embodiment, first electronic commercial transaction system 13 provides services and performs electronic commercial transactions on transaction terminal 22.

First electronic commercial transaction system 13 is an electronic commercial transaction system relating to the sale of merchandise. Second electronic commercial transaction system 14 is an electronic commercial transaction system relating to transactions for payment settlement and distribution such as collection/delivery and shipping. This system can provide a plurality of information regarding the fee, processing time or processing interval related to payment settlement and distribution.

Next, the operation of the second preferred embodiment of the electronic commercial transaction system of the present invention will be described.

Firstly, the manufacturing wholesaler or intermediary wholesaler provides merchandise information of the sales item to first electronic commercial transaction system 13.

Then, service of first electronic commercial transaction system 13 proceeds on transaction terminal 22, and when an order is placed or received or information relating to the placement or reception of an order is obtained, that information is transmit via information route 32 to second electronic commercial transaction system 14, and second electronic commercial transaction system 14 activates.

If placement or reception of an order is established, payment settlement processing will be necessary. Among payment methods, there are many types of payment services offered by financial organizations. Each service differs with respect to the time, date, handling fees, etc. required for the payment settlement. Moreover, in the case of transactions with manufacturers, intermediary wholesalers and retail stores, because payments will be for a large sum, the payment is related to the status of an individual's credit guarantee, and selection of various services is possible, as well as necessary.

From among these diverse services, the selection of a commission-based service for payment settlement is itself a type of commercial transaction. Similar to the first preferred embodiment, second electronic commercial transaction system 14 provides this as an electronic commercial transaction service.

Furthermore, in the preferred embodiment shown in FIG. 2, the merchandise provider is a manufacturing wholesaler or intermediary wholesaler, and the merchandise purchaser is another intermediary wholesaler or retail store. This type of merchandise provider does not sell merchandise one item at a time, but rather sells a plurality of types of merchandise to a plurality of buyers. On the other hand, for each procurement, the intermediary wholesaler, retail store, etc. that is the buyer, does not purchase merchandise one item at a time, but rather purchases a plurality of types of merchandise from a plurality of merchandise providers.

Therefore, in the second preferred embodiment, if a plurality of placed or received orders are established, a complex merchandise collection/delivery process will be necessary.

As the number of goods for collection/delivery increase, the diversity of various services for merchandise collection/delivery will increase. Various services exist depending on the collection/delivery region, or shipping between collection/delivery regions.

Therefore, with the selection of a collection/delivery company and a shipping company to ship between collection/delivery regions, less expensive collection/delivery can be obtained. However, this is itself a type of transaction. Second electronic commercial transaction system 14 provides this type of electronic commercial transaction service for distribution.

In this type of transaction, payment settlement and distribution commission-based companies are selected based on their fees and processing times. Because second electronic commercial transaction system 14 provides transaction-related information regarding the fee, processing time, or processing interval as a plurality of comparative information, less expensive and more convenient selections can be made.

(Third Preferred Embodiment)

FIG. 3 shows the third preferred embodiment of the electronic commercial transaction system of the present invention. This electronic commercial transaction system provides transactions for payment settlement, distribution, and goods processing derived especially from the buying and selling of merchandise.

This third preferred embodiment of the electronic commercial transaction system, as shown in FIG. 3, is comprised of first electronic commercial transaction system 15, second electronic commercial transaction system 16, transaction terminal 23, and information route 33. Similar to the first preferred embodiment, first electronic commercial transaction system 15 and second electronic commercial transaction system 16 provide services and perform electronic transactions on transaction terminal 23.

First electronic commercial transaction system 15 is an electronic commercial transaction system for the sale of materials and here, as a specific example, is a transaction system for fabric and secondary materials for clothing and accessories. Second electronic commercial transaction system 16 is an electronic commercial transaction system that provides transactions related to payment settlement, distribution, and goods processing; here, the sewing of clothing and accessories will be presented as a specific example of goods processing.

Next, the operation of the third preferred embodiment of the electronic commercial transaction system of the present invention will be described.

Firstly, if merchandise information of the sales items, i.e. the fabric and secondary materials of clothing and accessories, is provided to first electronic commercial transaction system 15, the services of first electronic commercial transaction system 15 will proceed. When an order is placed or received or information relating to the placement or reception of an order is obtained, that information is transmit via information route 33 to second electronic commercial transaction system 16, and second electronic commercial transaction system 16 activates.

In the clothing and accessory market, the quantity of sales depends greatly on the merchandise design and the plans of consumers. Moreover, due to seasonal fluctuations, the period of time during which a product can be sold is extremely limited.

Therefore, there is a tendency for some specific merchandise to be consumed in large quantities and to become scarce, while large quantities of other specific merchandise will remain as unsold stock.

Under these circumstances, the materials that constitute the fabric and secondary materials of clothing items or accessories will naturally be excessively scarce in some cases and a surplus in other cases. Further, even in the fabric sewing industry, insufficiencies and oversupplies of processing capacity will occur.

In the case where products made in-house by a manufacturing wholesaler are scarce, when fabric and secondary materials of clothing items or accessories are purchased with first electronic commercial transaction system 15, at that time, the in-house sewing capacity will naturally become insufficient. As for fabric sewing, external commissioned transactions are desired.

Thus, after the placement or reception of an order is established for first electronic commercial transaction system 15, similar to the first and second preferred embodiments, the activated second electronic commercial transaction system 16 provides services relating to payment settlement and distribution, and in addition, provides services including bidding process transactions relating to the processing of goods transacted with first electronic commercial transaction system 15. The provided information is similar to that of the first and second preferred embodiments in that it includes fee, processing time, and processing interval information relating to a plurality of choices.

After it has been decided to purchase goods, in other words, after materials procurement, conditions favorable to the processing or to transactions relating to the sewing processing cannot be obtained in some cases. In these cases, the steps for materials procurement become troublesome. However, because second electronic commercial transaction system 16 will activate if information relating to the placement or reception of orders can be obtained and because it is unnecessary to establish order placement or reception in first electronic transaction system 15, purchasing can also be decided upon verification of the steps after materials procurement.

(Fourth Preferred Embodiment)

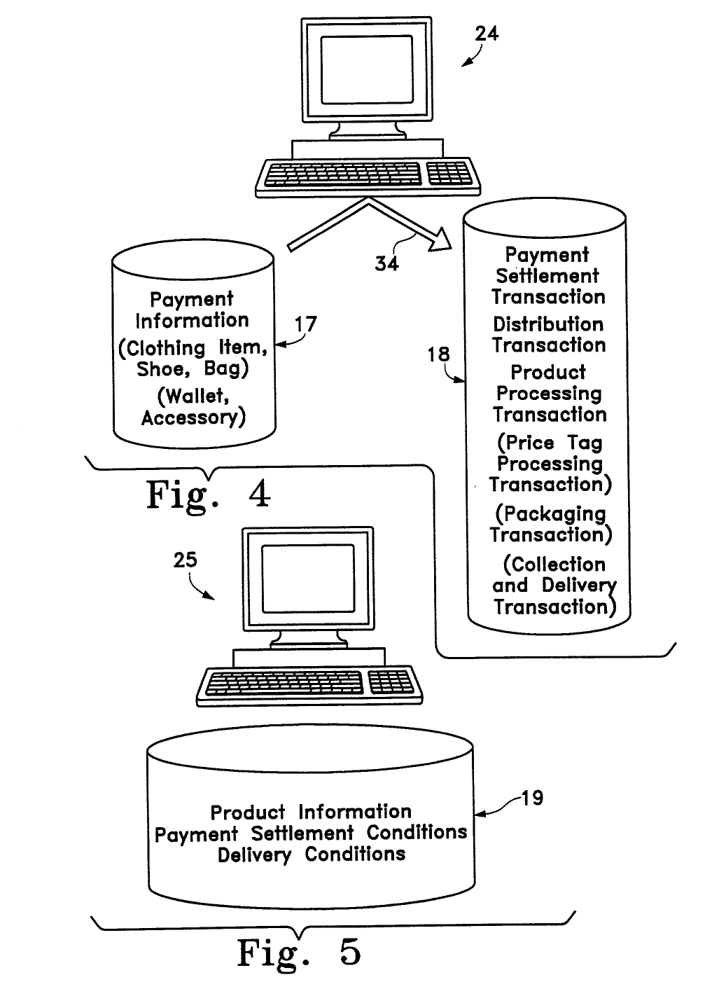

FIG. 4 shows the fourth preferred embodiment of the electronic commercial transaction system of the present invention. This electronic commercial transaction system provides transactions for payment settlement, distribution, and distribution processing derived especially from product sales and the placed or received orders.

The fourth preferred embodiment is comprised of first electronic commercial transaction system 17, second electronic commercial transaction system 18, transaction terminal 24, and information route 34. Similar to the first preferred embodiment, first electronic commercial transaction system 17 and second electronic commercial transaction system 18 provide services and perform electronic transactions on transaction terminal 24.

First electronic commercial transaction system 17 is an electronic commercial transaction system for the sale of products and here, as a specific example, is a system that performs transactions for fashion products such as clothing and accessory items, shoes, bags, wallets, accessories, etc. Second electronic commercial transaction system 18 is an electronic commercial transaction system that provides transactions for payment settlement and distribution processing including the processing of collection/delivery, packaging, shipping, price tags, merchandise identifier code tags, manufacturing wholesaler identifying tags, retail store identifying tags, etc.

Next, the operation of the fourth preferred embodiment of the electronic commercial transaction system of the present invention will be described.

Firstly, if the manufacturer wholesaler or intermediary wholesaler provides merchandise information of the sales items, i.e. fashion products such as clothing and accessory items, shoes, bags, wallets, and accessories, to first electronic commercial transaction system 17, the services of first electronic commercial transaction system 17 will proceed. When an order is placed or received or information relating to the placement or reception of an order is obtained, that information is transmitted via information route 34 to second electronic commercial transaction system 18. This activates second electronic commercial transaction system 18.

Thus, similar to the first through third preferred embodiments, second electronic commercial transaction system 18 provides services, including bidding process transactions, relating to payment settlement and distribution. Moreover, the provided information is similar to that of the first through third preferred embodiments in that it includes fee, processing time, and processing interval information relating to a plurality of choices.

In the market of fashion products, especially in the clothing and accessory market, the quantity of sales depends greatly on the merchandise design and the plans of consumers. Moreover, due to seasonal fluctuations, the period of time during which a product can be sold is extremely limited. Therefore, as stated above, there is a tendency for some specific merchandise to be consumed in large quantities and to become scarce, while large quantities of other specific merchandise will remain as unsold stock.

Further, in consideration of seasonal fluctuations, regional product consumption will be biased according to the warming or cooling of temperatures.

Therefore, the manufacturer wholesalers or intermediary wholesalers who retain unsold stock provide merchandise information to first electronic commercial transaction system 17 in the hope that intermediary wholesalers or retail stores in other regions will purchase these goods. Consequently, the transacted products are shipped to regions and retail stores that differ from the original intentions. Also, they are sold at prices that differ from the original intentions.

Under these circumstances, there are demands for attaching price tags and retail store identification tags, and for attaching and removing merchandise and manufacturing origin identification tags. Various specialized dealers are competing to provide low cost service for these types of distribution processes.

Therefore, second electronic commercial transaction system 18 provides service for transactions related to these types of processes as one of the processes for placing or receiving orders with first electronic commercial transaction system 17.

Even in this type of transaction, since selection of a commission-based distribution processing company is mostly based on fees and processing times, second electronic commercial transaction system 18 provides transaction-related information regarding the fee, processing time, or processing interval. Moreover, so that the selection can be made less expensively and more conveniently, a plurality of comparative information is provided.

### EFFECTS OF THE INVENTION

As is evident from the above description based on the preferred embodiments, instead of processing just a single electronic commercial transaction, the electronic commercial transaction system of the present invention organically provides a new electronic commercial transaction service relating to the payment settlement, goods processing, distribution processing, etc. that accompany electronic commercial transactions, and overall, provides cheaper and more convenient service.

1. An electronic commercial transaction system comprising:
a first electronic commercial transaction system that handles the placing or receiving of orders, and a second electronic commercial transaction system that provides transactions related to the processing derived from the order placing or receiving handled by the first electronic commercial transaction system.

2. An electronic commercial transaction system as recited in claim 1, wherein a second electronic commercial transaction system is activated upon receipt of order placing or receiving information that is transmitted from the first electronic commercial transaction system.

3. An electronic commercial transaction system as recited in claim 1, wherein at least either the first electronic commercial transaction system or the second electronic commercial transaction system provides transactions by a bidding process.

4. An electronic commercial transaction system as recited in claim 1, wherein the first electronic commercial transaction system is involved in transactions with at least one of the following: materials wholesalers, processors, manufacturing wholesalers, intermediary wholesalers, and retail stores.

5. An electronic commercial transaction system as recited in claim 1, wherein the second electronic commercial transaction system provides a transaction that is at least one of the following: payment of the fee that accompanies the placing or receiving of an order, processing of the goods for which an order was placed or received, packaging of the goods for which an order was placed or received, collection/delivery and shipping of the goods for which an order was placed or received, processing of the labels attached to the goods for which an order was placed or received, processing of tags that identify the goods, processing of tags that identify the origin of manufacture, or processing of tags that identify the origin of sale.

6. An electronic commercial transaction system as recited in claim 5, wherein the information provided by the second electronic commercial transaction system is at least either the fee or processing time related to the processing derived from the order place or received with the first electronic commercial transaction system.

7. An electronic commercial transaction system as recited in claim 6, wherein the second electronic commercial transaction system provides information that is related to the processing derived from the placed or received order handled by the first electronic commercial transaction system and includes a plurality of information for the same item to enable comparison.

8. An electronic commercial transaction system as recited in claim 1, wherein the first electronic commercial transaction system provides transactions related to at least either fabric or secondary materials of clothing items or accessories.

9. An electronic commercial transaction system as recited in claim 8, wherein the second electronic commercial transaction system provides transactions related to the sewing of clothing and accessories.

10. An electronic commercial transaction system as recited in claim 1, wherein the first electronic commercial transaction system provides transactions related to at least one of the following: clothing items, shoes, bags, wallets, or accessories.
